(19) United States
(12) Patent Application Publication
(10) Pub. No.: US 2025/0304129 A1
(43) Pub. Date: Oct. 2, 2025

(54) Motorized Beach Wagon Device

(71) Applicants: Christine Lennon, Hickory Corners, MI (US); Ashley Lennon, Hickory Corners, MI (US)

(72) Inventors: Christine Lennon, Hickory Corners, MI (US); Ashley Lennon, Hickory Corners, MI (US)

(21) Appl. No.: 18/744,834

(22) Filed: Jun. 17, 2024

Related U.S. Application Data
(60) Provisional application No. 63/571,594, filed on Mar. 29, 2024.

(51) Int. Cl. B62B 3/00; B62B 3/02; B62B 5/00; B62B 5/06

(52) U.S. Cl. CPC B62B 3/007; B62B 3/025; B62B 5/0033; B62B 5/065; B62B 2205/06

(57) ABSTRACT

A motorized beach wagon device is disclosed for easily transporting supplies and gear to a beach or over other rough terrain. The motorized beach wagon device comprises a body component that is configured in a rectangular shape and comprised of a frame and handle with a fabric insert. The fabric insert comprises a plurality of pockets and is held to the metal frame via Velcro during use. The fabric insert can be removed and the metal frame collapsed for storage and transport. The frame is secured to a plurality of large wheels designed to travel over the sand. Further, the frame and handle comprise a battery-operated motor which is rechargeable, and a throttle button.

### CROSS-REFERENCE TO RELATED APPLICATION

The present application claims priority to, and the benefit of, U.S. Provisional Application No. 63/571,594, which was filed on Mar. 29, 2024, and is incorporated herein by reference in its entirety.

### FIELD OF THE INVENTION

The present invention relates generally to the field of motorized beach wagon devices. More specifically, the present invention relates to an improved motorized wagon/cart for a beach. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in motorized beach wagon devices. Generally, pulling wagons or other carts through beach sand can be a physically demanding and difficult process. Further, pulling a large amount of gear over soft sand is extremely difficult, especially when trying to cross thick drifts of sand. Users need an easier way to enjoy a day at the beach without the struggle of carrying loads of equipment and supplies.

Further, after driving to the shore, beachgoers typically find parking a considerable distance from the actual location selected for the day's outing. Often, a long walk across the sand is required which may be particularly burdensome when handling a combination of children, large beach towels, beach chairs, children's toys, umbrellas, extra clothes, coolers filled with food and drink, and other paraphernalia for the beach. Without a wagon or similar device, the beachgoer frequently makes several round trips, all the while attempting to maintain control over the operation. However, most wagons/carts tend to sink into soft sand, and, when loaded become difficult to manage on the soft sand terrain.

Accordingly, there is a demand for an improved motorized beach wagon device that provides a motorized wagon/cart for the beach with large wheels to travel over the sand. More particularly, there is a demand for a motorized beach wagon device that is collapsible for easy transport/storage.

Therefore, there exists a long-felt need in the art for a motorized beach wagon device that provides users with a motorized wagon/cart for the beach. There is also a long-felt need in the art for a motorized beach wagon device that comprises large wheels designed to travel over the sand. Further, there is a long-felt need in the art for a motorized beach wagon device that has a rechargeable motor. Moreover, there is a long-felt need in the art for a device that has a metal frame with a fabric insert for holding supplies and gear. Further, there is a long-felt need in the art for a motorized beach wagon device that is collapsible for easy transport and storage. Finally, there is a long-felt need in the art for a motorized beach wagon device that has a plurality of pockets.

The subject matter disclosed and claimed herein, in one embodiment thereof, comprises a motorized beach wagon device. The device is a multipurpose, motorized beach wagon/cart for easily transporting supplies and gear to a beach or over other rough terrain. The motorized beach wagon device comprises a body component that is configured in a rectangular shape and comprised of a frame and handle with a fabric insert. The fabric insert comprises a plurality of pockets and is held to the metal frame via Velcro during use. The fabric insert can be removed and the metal frame collapsed for storage and transport. The frame is secured to a plurality of large wheels designed to travel over the sand. Further, the frame and handle comprise a battery-operated motor which is rechargeable, and a throttle button.

In this manner, the motorized beach wagon device of the present invention accomplishes all of the foregoing objectives and provides users with a device that provides a motorized wagon/cart for the beach. The device has a battery-operated motor and large wheels for traveling on the sand. The device can be collapsed for storage/transport.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized beach wagon device. The device is a multipurpose, motorized beach wagon/cart for easily transporting supplies and gear to a beach or over other rough terrain. The motorized beach wagon device comprises a body component that includes a frame and handle with a fabric insert. The fabric insert comprises a plurality of pockets and is secured to the frame during use. The frame is secured to a plurality of large wheels designed to travel over the sand. Further, the frame and handle comprise a battery-operated motor which is rechargeable, and a throttle button.

The present invention is directed to a motorized beach wagon device that has particular utility in transporting beach gear and supplies, such as beach chairs, beach towels, children's toys, coolers, and other beach paraphernalia, etc. In the present invention, the motorized beach wagon device can be steered and easily pulled at a comfortable walking speed of the user. Although the device is manually steerable, the device adapts to various terrains, such as a parking lot surface, pavement, soft sand, and hard sand, etc. Accordingly, the wagon device has large wheels with treaded tires, a handle for steering, and a rechargeable motor, to allow transport of heavy loads on a variety of terrains and elevation changes, enabling high control of the wagon device and little pulling effort by the user.

In one embodiment, the motorized beach wagon device comprises a body component that is configured in a rectangular shape but can be any suitable shape and size as is known in the art. The body component comprises a frame and fabric insert. The frame is typically metal, such as aluminum or steel, but could also be manufactured of a durable plastic, as well. The frame comprises a plurality of rods and struts which are configured to form a rectangular frame for the device with a weight bearing center bar. The rods and struts comprise pin connections (i.e., pivot pins) to allow the frame to expand and collapse in a scissor-like motion. Thus, the frame can be expanded into an elongated rectangular configuration during use or collapsed together for storage. In other words, in the collapsed mode, the size and/or the volume occupied by the device is significantly reduced, thereby facilitating efficient storage and ease of transport. Further, the frame can be locked and unlocked in either position (i.e., collapsed and expanded).

In one embodiment, the fabric insert is inserted within the frame and secured to the edges of the frame during use. Typically, the fabric insert is releasably secured to the frame via Velcro, snaps, zippers, buckles, etc., or any other suitable securing means as is known in the art. Specifically, the fabric insert has soft sides and bottom sections and fits onto the folding frame, much like a liner. The fabric insert is preferably made of a durable material, such as, but not limited to, woven fabric, canvas, nylon, etc. In use, the fabric insert is inserted into the expanded frame and secured via Velcro. When a user wants to collapse the device, the fabric insert is removed and the frame is collapsed for storage.

In one embodiment, the fabric insert comprises a plurality of pockets positioned on the interior and exterior of the fabric insert. Any suitable number of pockets can be utilized as is known in the art. Further, the plurality of pockets can be any suitable size and shape as is known in the art. The pockets can be mesh so the contents can be seen or a solid material pocket (i.e., made from the same material as the fabric insert) so the contents cannot be seen. The pockets can be open at the top or be secured via a Velcro flap, snaps, zippers, buckles, etc.

In one embodiment, the motorized beach wagon device comprises a plurality of wheels secured via axles to the frame. The wheels can be any suitable number and shape and size as is known in the art. Typically, the device comprises four wheels, with one wheel secured to each corner of the frame. Specifically, the frame comprises a front axle and a rear axle with a set of wheels secured to each axle via a simple nut and bolt threaded connection. The wheels are large enough to displace up to approximately 80 pounds of weight during use. Further, the wheels are typically large wheels with large tire treads to help the device move through thick drifts of sand during use.

In one embodiment, the motorized beach wagon device comprises a handle that connects to a steering linkage assembly, and the steering linkage assembly connects to the folding frame, and the front wheels. The steering linkage assembly is preferably made of, but not limited to, aluminum or steel. The linkage assembly is preferably configured, but not limited to, synchronized swivels above each wheel or a pinned connection to the front axle. The handle with the steering linkage assembly allows a user to steer the device, while in use. The handle can be any suitable shape and size as is known in the art, as long as the handle is long enough to allow a user to easily pull the device while walking. The handle can also comprise a textured grip area for non-slip grip and/or a grip section that allows a user to insert their hand through while pulling the device. In one embodiment, the handle is a telescoping handle that can be expanded and collapsed as needed.

In one embodiment, the handle comprises a battery for powering the device. The battery is typically positioned in the body of the handle but can be in any suitable position on the handle or the device as is known in the art. The battery is a rechargeable battery and is typically a USBC rechargeable battery for powering an electric motor.

In one embodiment, the handle comprises a controller, which is a throttle button or on/off switch for turning on and off the attached motor. In another embodiment, the handle also comprises a forward/backward switch, as well as the on/off switch (i.e., throttle switch) to control the movement of the device during use.

In one embodiment, the device comprises at least one motor that connects to a drive assembly, and the drive assembly connects to the front and rear wheels. Preferably, the motor is a DC motor powered by the battery, which allow the motor to be rechargeable. Typically, the electric motor is in mechanical communication with the drive assembly and attached wheels to drive the wheels. Any suitable number of electric motors can be used to drive the device during use and the motors can be positioned in any suitable place on the device. Further, the motor, the battery, and the controller are all in electrical communication with each other to move the device. The motor, battery, and controller, as well as the throttle switches, are all configured to fit within the handle or the device. However, options are available for wired or wireless controls, as well.

In yet another embodiment, the motorized beach wagon device comprises a plurality of indicia.

In yet another embodiment, a method of easily transporting supplies and gear on a beach is disclosed. The method includes the steps of providing a motorized beach wagon device comprising a body component with a frame, handle, and a fabric insert. The method also comprises securing the fabric insert to the expanded frame via Velcro. Further, the method comprises inserting supplies and gear into the fabric insert for transport. The method also comprises utilizing the handle, battery-operated motor, and large wheels to easily transport the supplies and gear to the beach. Finally, the method comprises removing the fabric insert and collapsing the frame for storage.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the motorized beach wagon device of the present invention in accordance with the disclosed architecture;

FIG. 2 illustrates a perspective view of one embodiment of the motorized beach wagon device of the present invention showing the interior of the fabric insert in accordance with the disclosed architecture;

FIG. 3 illustrates a perspective view of one embodiment of the motorized beach wagon device of the present invention showing the pockets of the fabric insert in accordance with the disclosed architecture;

FIG. 4 illustrates a perspective view of one embodiment of the motorized beach wagon device of the present invention showing how the fabric insert is secured to the metal frame in accordance with the disclosed architecture;

FIG. 5 illustrates a perspective view of one embodiment of the motorized beach wagon device of the present invention showing the wheels secured to the frame in accordance with the disclosed architecture;

FIG. 6 illustrates a perspective view of one embodiment of the motorized beach wagon device of the present invention showing the device collapsed in accordance with the disclosed architecture;

FIG. 7 illustrates a perspective view of one embodiment of the motorized beach wagon device of the present invention showing the fabric insert removed when collapsed in accordance with the disclosed architecture;

FIG. 8 illustrates a perspective view of one embodiment of the motorized beach wagon device of the present invention showing the handle with rechargeable battery in accordance with the disclosed architecture;

FIG. 9 illustrates a perspective view of one embodiment of the motorized beach wagon device of the present invention showing the rechargeable battery removed in accordance with the disclosed architecture;

FIGS. 10A-F illustrate a perspective view of one embodiment of the motorized beach wagon device of the present invention showing how it can be collapsed in accordance with the disclosed architecture;

FIGS. 11A-B illustrate a perspective view of one embodiment of the motorized beach wagon device of the present invention showing the device expanded and collapsed in accordance with the disclosed architecture; and

FIG. 12 illustrates a flowchart showing the method of easily transporting supplies and gear on a beach in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a motorized beach wagon device that provides users with a motorized wagon/cart for the beach. There is also a long-felt need in the art for a motorized beach wagon device that comprises large wheels designed to travel over the sand. Further, there is a long-felt need in the art for a motorized beach wagon device that has a rechargeable motor. Moreover, there is a long-felt need in the art for a device that has a metal frame with a fabric insert for holding supplies and gear. Further, there is a long-felt need in the art for a motorized beach wagon device that is collapsible for easy transport and storage. Finally, there is a long-felt need in the art for a motorized beach wagon device that has a plurality of pockets.

The present invention, in one exemplary embodiment, is a novel motorized beach wagon device. The motorized beach wagon device comprises a body component that is configured in a rectangular shape and comprised of a frame and handle with a fabric insert. The fabric insert comprises a plurality of pockets and is held to the metal frame via Velcro during use. The fabric insert can be removed and the metal frame collapsed for storage and transport. The frame is secured to a plurality of large wheels designed to travel over the sand. Further, the frame and handle comprise a battery-operated motor which is rechargeable, and a throttle button. The present invention also includes a novel method of easily transporting supplies and gear on a beach. The method includes the steps of providing a motorized beach wagon device comprising a body component with a frame, handle, and a fabric insert. The method also comprises securing the fabric insert to the expanded frame via Velcro. Further, the method comprises inserting supplies and gear into the fabric insert for transport. The method also comprises utilizing the handle, battery-operated motor, and large wheels to easily transport the supplies and gear to the beach. Finally, the method comprises removing the fabric insert and collapsing the frame for storage.

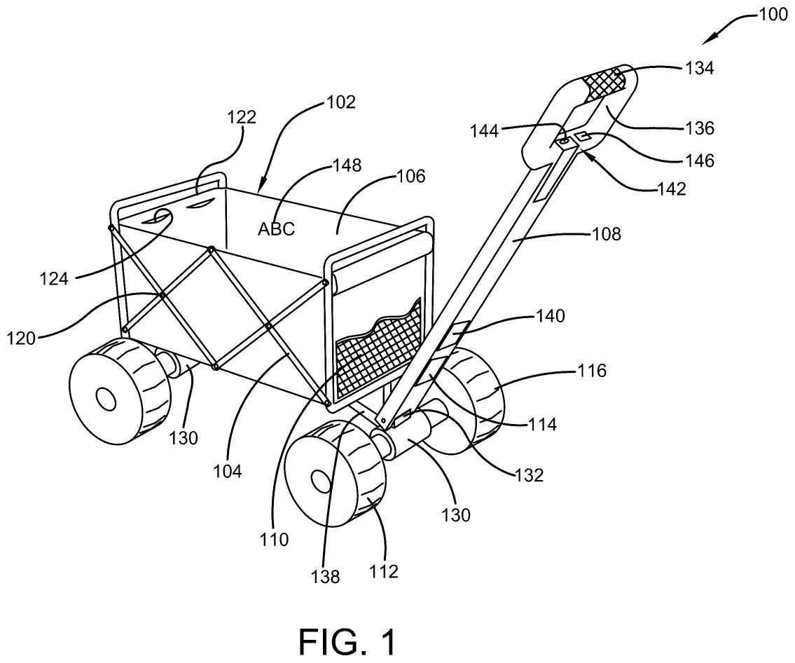

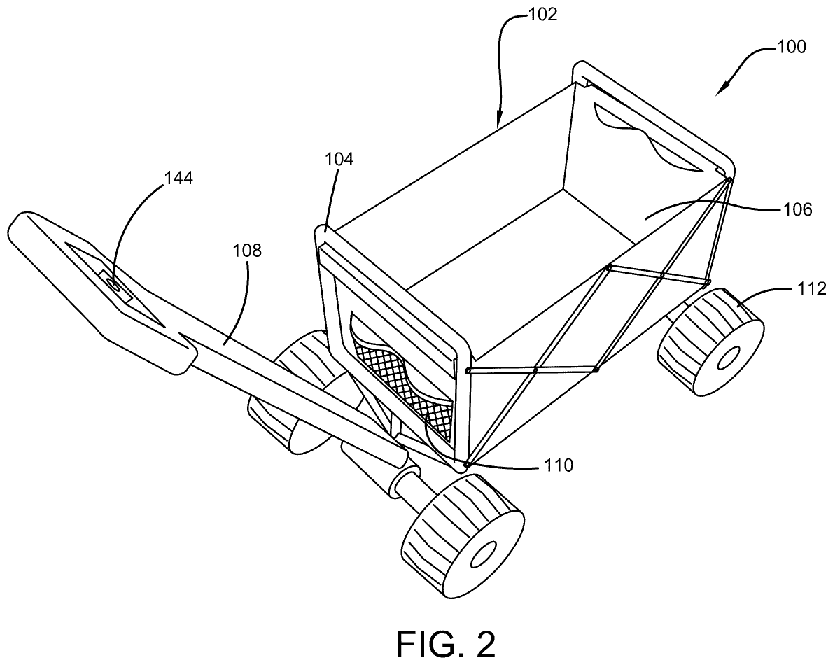

Referring initially to the drawings, FIGS. 1-2 and 10A-F illustrate a perspective view of one embodiment of the motorized beach wagon device 100 of the present invention. In the present embodiment, the motorized beach wagon device 100 is an improved motorized beach wagon device 100 that provides a user with a multipurpose, motorized wagon/cart for transporting supplies and gear over rough terrain. Specifically, the motorized beach wagon device 100 comprises a body component 102 with a frame 104 and fabric insert 106 and handle 108. The fabric insert 106 comprises a plurality of pockets 110 and is secured to the frame 104 during use. The frame 104 is secured to a plurality of large wheels 112 designed to travel over the terrain. Further, the frame 104 and handle 108 comprise a battery-operated motor 114 which is rechargeable.

Generally, the present invention is directed to a motorized beach wagon device 100 that has particular utility in transporting beach gear and supplies, such as beach chairs, beach towels, children's toys, coolers, and other beach paraphernalia, etc. In the present invention, the motorized beach wagon device 100 can be steered and easily pulled at a comfortable walking speed of the user. Although the device 100 is manually steerable, the device 100 adapts to various terrains, such as a parking lot surface, pavement, soft sand, and hard sand, etc. Accordingly, the wagon device 100 has large wheels 112 with treaded tires 116, a handle 108 for steering, and a rechargeable motor 114, to allow transport of heavy loads on a variety of terrains and elevation changes, enabling high control of the wagon device 100 and little pulling effort by the user.

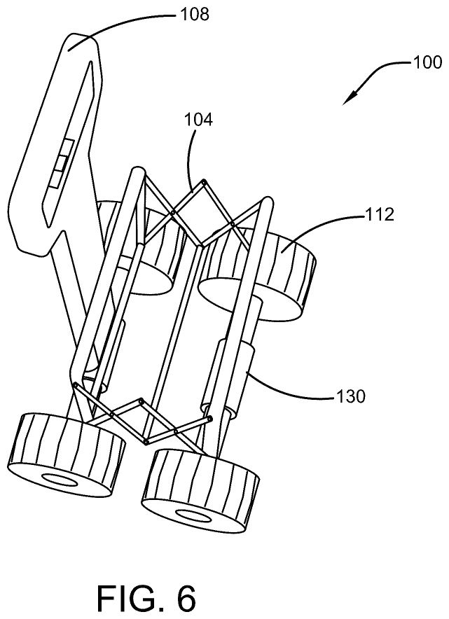

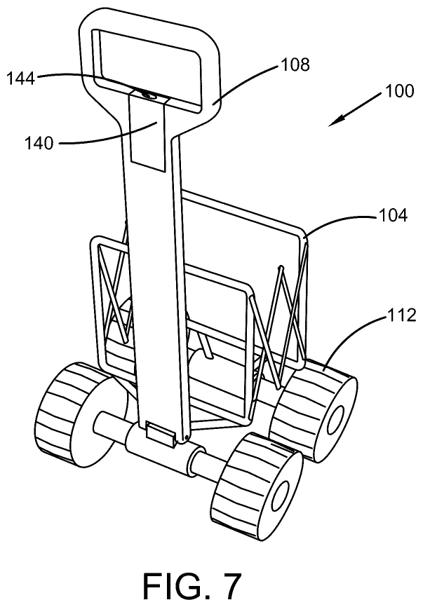

As shown in FIGS. 1-2 and 6-7, the motorized beach wagon device 100 comprises a body component 102 that is configured in a rectangular shape but can be any suitable shape and size as is known in the art. The body component 102 comprises a frame 104 and fabric insert 106. The frame 104 is typically metal, such as aluminum or steel, but could also be manufactured of a durable plastic, as well. The frame 104 comprises a plurality of rods and struts which are configured to form a rectangular frame for the device 100 with a weight bearing center bar 118. The rods and struts comprise pin connections 120 (i.e., pivot pins) to allow the frame 104 to expand and collapse in a scissor-like motion. Thus, the frame 104 can be expanded into an elongated rectangular configuration during use or collapsed together for storage. In other words, in the collapsed mode, the size and/or the volume occupied by the device 100 is significantly reduced, thereby facilitating efficient storage and ease of transport. Further, the frame 104 can be locked and unlocked in either position (i.e., collapsed and expanded), as desired.

Further, the fabric insert 106 is inserted within the frame 104 and secured to the edges 122 of the frame 104 during use. Typically, the fabric insert 106 is releasably secured to the frame 104 via Velcro 124, snaps, zippers, buckles, etc., or any other suitable securing means as is known in the art. Specifically, the fabric insert 106 has soft sides and bottom sections and fits onto the folding frame 104, much like a liner. The fabric insert 106 is preferably made of a flexible, durable material, such as, but not limited to, woven fabric, canvas, nylon, etc. In use, the fabric insert 106 is inserted into the expanded frame 104 and secured via Velcro 124. When a user wants to collapse the device 100, the fabric insert 106 is removed and the frame 104 is collapsed for storage.

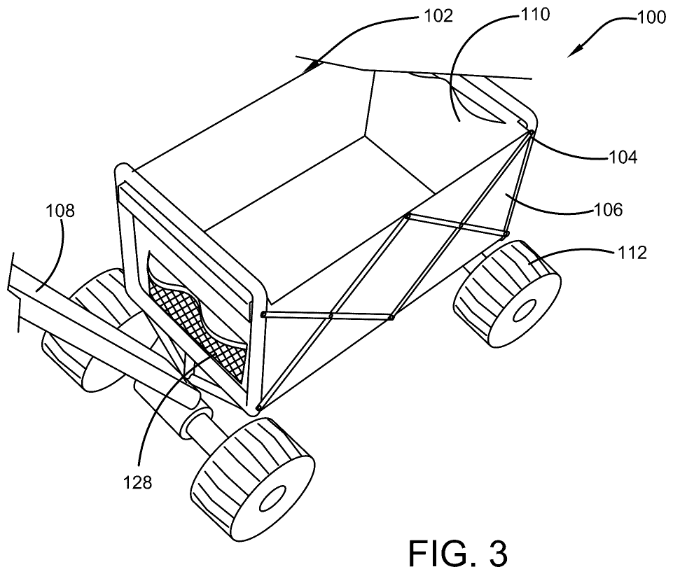

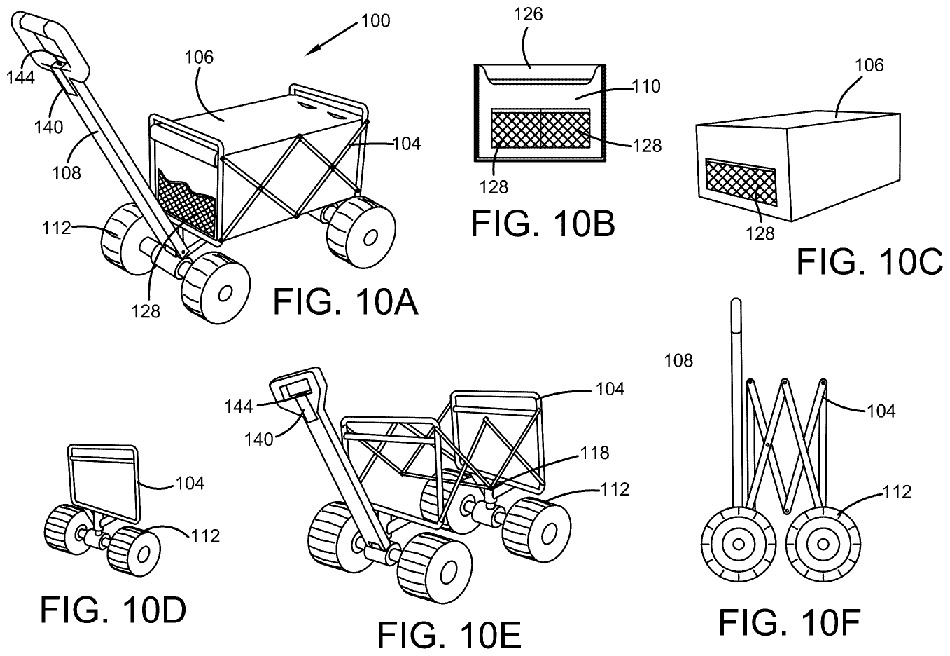

As shown in FIGS. 3 and 10A-F, the fabric insert 106 comprises a plurality of pockets 110 positioned on the interior and/or exterior of the fabric insert 106. Any suitable number of pockets 110 can be utilized as is known in the art. Further, the plurality of pockets 110 can be any suitable size and shape as is known in the art. The pockets 110 can be mesh 128 so the contents can be seen or a solid material pocket (i.e., made from the same material as the fabric insert 106) so the contents cannot be seen. The pockets 110 can be open at the top or be secured via a Velcro flap 126, snaps, zippers, buckles, etc. Typically, the mesh pockets 128 are positioned on the back, front, and insides of the fabric insert 106, and the solid material pockets are positioned on the inside of the fabric insert 106, but the pockets 110 can be positioned in any suitable place on the fabric insert 106, depending on the needs and/or wants of a user.

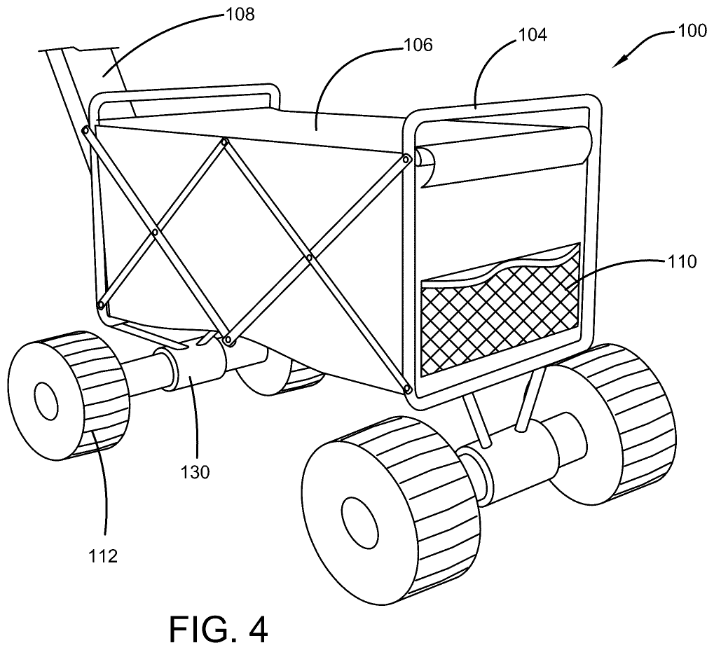

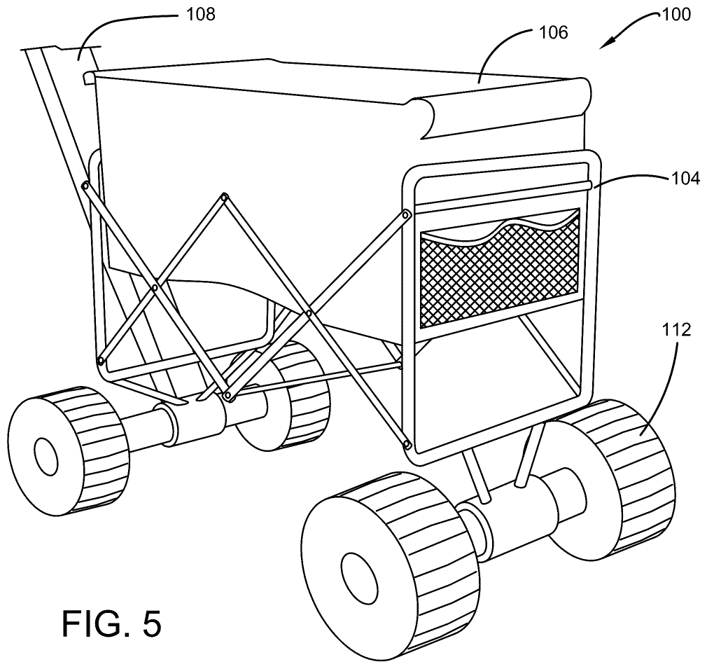

As shown in FIGS. 4-5, the motorized beach wagon device 100 comprises a plurality of wheels 112 secured via axles 130 to the frame 104. The wheels 112 can be any suitable number and shape and size as is known in the art. Typically, the device 100 comprises four wheels 112, with one wheel 112 secured to each corner of the frame 104. Specifically, the frame 104 comprises a front axle 130 and a rear axle 130 with a set of wheels 112 secured to each axle 130 via a simple nut and bolt threaded connection. The wheels 112 are large enough to displace up to approximately 80 pounds of weight during use. Further, the wheels 112 are typically large wheels with large tire treads 116 to help the device 100 move through thick drifts of sand during use.

As shown in FIGS. 1-2 and 10A-F, the motorized beach wagon device 100 comprises a handle 108 that connects to a steering linkage assembly 132, and the steering linkage assembly 132 connects to the folding frame 104, and the front wheels 112. The steering linkage assembly 132 is preferably made of, but not limited to, aluminum or steel. The linkage assembly 132 is preferably configured, but not limited to, synchronized swivels above each wheel 112 or a pinned connection to the front axle 130. The handle 108 with the steering linkage assembly 132 allows a user to steer the device 100, while in use. The handle 108 can be any suitable shape and size as is known in the art, as long as the handle 108 is long enough to allow a user to easily pull the device 100 while walking. The handle 108 can also comprise a textured grip area 134 for non-slip grip and/or a grip section 136 that allows a user to insert their hand through while pulling the device 100. In one embodiment, the handle 108 is a telescoping handle that can be expanded and collapsed as needed.

Further, the device 100 comprises at least one motor 114 that connects to a drive assembly 138, and the drive assembly 138 connects to the front and rear wheels 112. Preferably, the motor 114 is a DC motor powered by a battery 140, which allow the motor 114 to be rechargeable. Typically, the electric motor 114 is in mechanical communication with the drive assembly 138 and attached wheels 112 to drive the wheels 112. Any suitable number of electric motors 114 can be used to drive the device 100 during use and the motors 114 can be positioned in any suitable place on the device 100. Further, the motor 114, the battery 140, and a controller 142 are all in electrical communication with each other to move the device 100. Specifically, the motor 114, battery 140, and controller 142, as well as a throttle switch 144 are all configured to fit within the handle 108 or the device 100 itself. However, options are available for wired or wireless controls, as well.

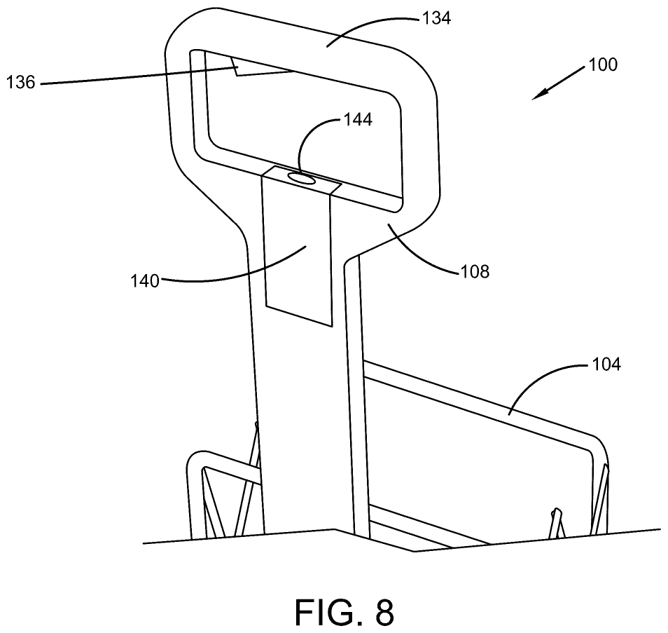

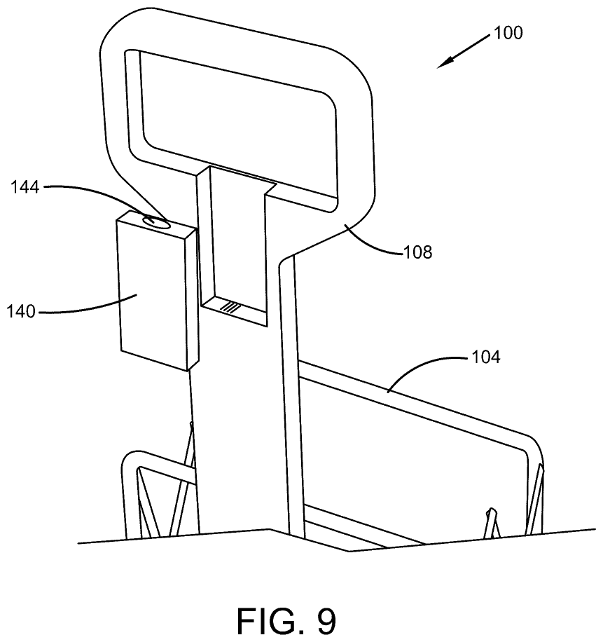

As shown in FIGS. 8-9, the handle 108 comprises a battery 140 for powering the device 100. The battery 140 is typically positioned in the body of the handle 108 but can be in any suitable position on the handle 108 or the device 100 as is known in the art. The battery 140 is a rechargeable battery and is typically a USBC rechargeable battery for powering an electric motor 114.

Further, the handle 108 comprises a controller 142, which is a throttle button 144 or on/off switch for turning on and off the attached motor 114. In another embodiment, the handle 108 also comprises a forward/backward switch 146, as well as the on/off switch (i.e., throttle switch 144) to control the movement of the device 100 during use.

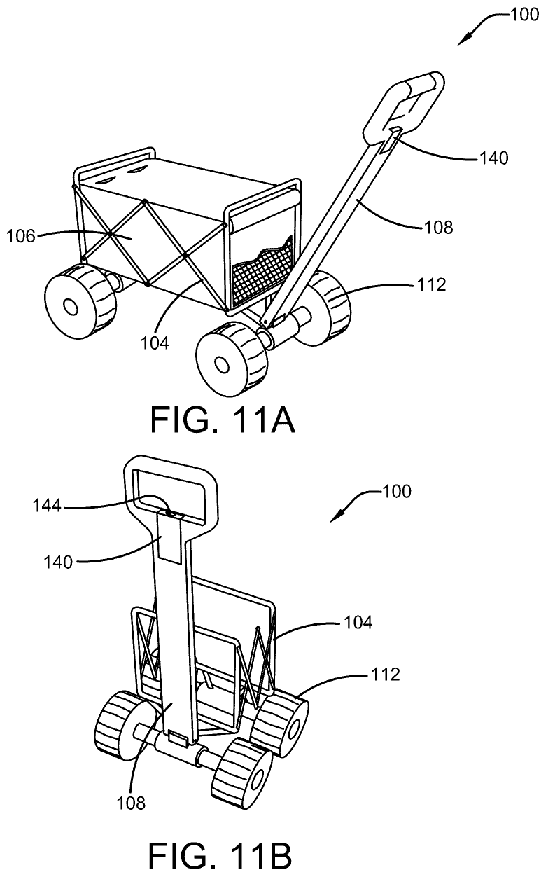

As shown in FIGS. 11A-B, in yet another embodiment, the motorized beach wagon device 100 comprises a plurality of indicia 148. The body component 102 of the device 100 may include advertising, a trademark, or other letters, designs, or characters, printed, painted, stamped, or integrated into the body component 102, or any other indicia 148 as is known in the art. Specifically, any suitable indicia 148 as is known in the art can be included, such as, but not limited to, patterns, logos, emblems, images, symbols, designs, letters, words, characters, animals, advertisements, brands, etc., that may or may not be beach wagon, motorized, or brand related.

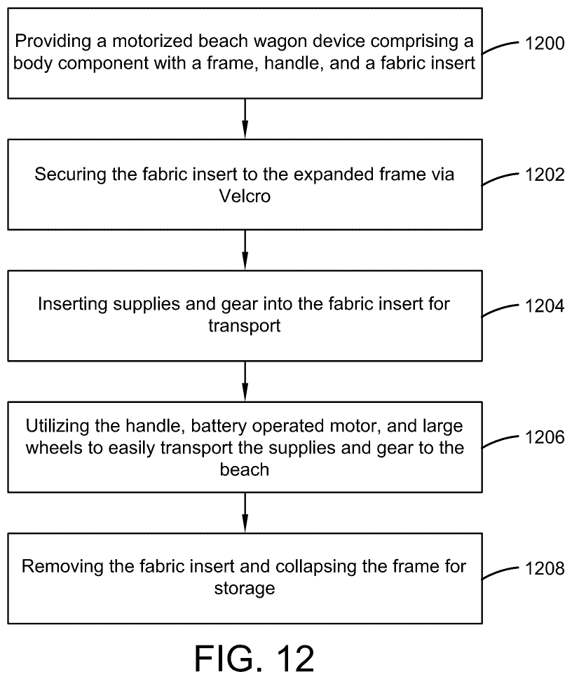

FIG. 12 illustrates a flowchart of the method of easily transporting supplies and gear on a beach. The method includes the steps of at 1200, providing a motorized beach wagon device comprising a body component with a frame, handle, and a fabric insert. The method also comprises at 1202, securing the fabric insert to the expanded frame via Velcro. Further, the method comprises at 1204, inserting supplies and gear into the fabric insert for transport. The method also comprises at 1206, utilizing the handle, battery-operated motor, and large wheels to easily transport the supplies and gear to the beach. Finally, the method comprises at 1208, removing the fabric insert and collapsing the frame for storage.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “motorized beach wagon device”, “beach wagon device”, “motorized device”, and “device” are interchangeable and refer to the motorized beach wagon device 100 of the present invention.

Notwithstanding the foregoing, the motorized beach wagon device 100 of the present invention can be of any suitable size and configuration as is known in the art without affecting the overall concept of the invention, provided that it accomplishes the above-stated objectives. One of ordinary skill in the art will appreciate that the motorized beach wagon device 100 as shown in FIGS. 1-12 is for illustrative purposes only, and that many other sizes and shapes of the motorized beach wagon device 100 are well within the scope of the present disclosure. Although the dimensions of the motorized beach wagon device 100 are important design parameters for user convenience, the motorized beach wagon device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized beach wagon device that provides a user with a multipurpose, motorized wagon for transporting supplies over rough terrain, the motorized beach wagon device comprising:
a body component;
a plurality of wheels;
a handle; and
a motor;
wherein the body component comprises a frame with a fabric insert secured to it;
wherein the handle is secured to the frame;
wherein the frame comprises the plurality of wheels; and
further wherein the body component comprises the motor, which drives the motorized beach wagon device to transport heavy loads on rough terrain with little pulling effort by a user.

2. The motorized beach wagon device of claim 1, wherein the frame comprises a plurality of rods and struts with pin connections which are configured to form a rectangular frame with a weight bearing center bar.

3. The motorized beach wagon device of claim 2, wherein the plurality of rods and struts with pin connections allow the frame to expand and collapse in a scissor-like motion.

4. The motorized beach wagon device of claim 3, wherein the fabric insert is inserted within the frame and secured to edges of the frame via Velcro flaps.

5. The motorized beach wagon device of claim 4, wherein the fabric insert comprises a plurality of pockets positioned on an interior and/or exterior of the fabric insert.

6. The motorized beach wagon device of claim 5, wherein some of the plurality of pockets are mesh and secured close via a Velcro flap at a top.

7. The motorized beach wagon device of claim 6, wherein the plurality of wheels are secured via a front axle and a rear axle to the frame.

8. The motorized beach wagon device of claim 7, wherein the plurality of wheels are large wheels with large tire treads to move through sand.

9. The motorized beach wagon device of claim 8, wherein the handle connects to a steering linkage assembly, and the steering linkage assembly connects to the frame and the plurality of wheels positioned in a front of the frame.

10. The motorized beach wagon device of claim 9, wherein the motor connects to a drive assembly, and the drive assembly connects to the plurality of wheels.

11. The motorized beach wagon device of claim 10, wherein the motor is powered by a rechargeable battery positioned in the handle.

12. The motorized beach wagon device of claim 11, wherein the handle comprises a controller, which is a throttle switch for turning on and off the motor.

13. A motorized beach wagon device that provides a user with a multipurpose, motorized wagon for transporting supplies over rough terrain, the motorized beach wagon device comprising:
a body component comprising a frame with a fabric insert;
a plurality of wheels that are large wheels with large tire treads to move through sand;
a handle; and
a motor;
wherein the frame comprises a plurality of rods and struts with pin connections which are configured to form a rectangular frame with a weight bearing center bar;
wherein the plurality of rods and struts with pin connections allow the frame to expand and collapse in a scissor-like motion;
wherein the fabric insert is inserted within the frame and secured to edges of the frame via Velcro flaps;
wherein the fabric insert comprises a plurality of pockets positioned on an interior and/or exterior of the fabric insert;
wherein the handle connects to a steering linkage assembly, and the steering linkage assembly connects to the frame and the plurality of wheels positioned in a front of the frame;
wherein the plurality of wheels are secured via a front axle and a rear axle to the frame;
wherein the electric motor connects to a drive assembly, and the drive assembly connects to the plurality of wheels;
wherein the electric motor is powered by a rechargeable battery positioned in the handle; and
wherein the handle comprises a controller, which is a throttle switch for turning on and off the electric motor.

14. The motorized beach wagon device of claim 13, wherein the handle comprises a forward/backward switch to control movement of the motorized beach wagon device.

15. The motorized beach wagon device of claim 13, wherein the handle comprises a textured grip area for non-slip gripping.

16. The motorized beach wagon device of claim 13, wherein the handle comprises a grip section that allows a user to insert their hand through while pulling the motorized beach wagon device.

17. The motorized beach wagon device of claim 13 further comprising a plurality of indicia.

18. The motorized beach wagon device of claim 13, wherein the electric motor, the battery, and the controller, as well as the throttle switch are all configured to fit within the handle.

19. The motorized beach wagon device of claim 13, wherein the electric motor is in mechanical communication with the drive assembly and the plurality of wheels to drive the motorized beach wagon device during use.

20. A method of easily transporting supplies and gear on a beach, the method comprising the following steps:
providing a motorized beach wagon device comprising a body component with a frame, handle, and a fabric insert;
securing the fabric insert to the expanded frame via Velcro;
inserting supplies and gear into the fabric insert for transport;
utilizing the handle, battery-operated motor, and large wheels to easily transport the supplies and gear to the beach; and
removing the fabric insert and collapsing the frame for storage.
